(19) United States
(12) Patent Application Publication
(10) Pub. No.: US 2013/0051569 A1
(43) Pub. Date: Feb. 28, 2013

(54) SYSTEM AND A METHOD FOR DETERMINING A POSITION OF A SOUND SOURCE

(71) Applicants: Kazuhiro NAKADAI, Wako-shi (JP); Hiroshi OKUNO, Kyoto-shi (JP); Takuma OTSUKA, Kyoto-shi (JP)

(72) Inventors: Kazuhiro NAKADAI, Wako-shi (JP); Hiroshi OKUNO, Kyoto-shi (JP); Takuma OTSUKA, Kyoto-shi (JP)

(73) Assignee: HONDA MOTOR CO., LTD., Tokyo (JP)

(21) Appl. No.: 13/590,624

(22) Filed: Aug. 21, 2012

(30) Foreign Application Priority Data
Aug. 24, 2011 (JP) 2011-182774

(51) Int. Cl. H04R 29/00

(52) U.S. Cl. 381/56

(57) ABSTRACT

In accordance with one aspect of the invention, the sound source position determining system comprises a detector (101) for detecting sound data, and a computing unit (103) for computing MUSIC spectrum for each direction and time. The system includes a state transition model that describes state and transition of the state according to existence or absence of sound sources in each direction, and a model parameter estimating unit (105) that determines an observation model describing MUSIC spectrum observed in a state where one or more sound sources exist and in a state where no sound sources exist and estimates posterior distribution of model parameters of the observation model and the state transition model based on temporal data of MUSIC spectrum. The system further comprises a unit (107) for determining positions of one or more sound sources by sampling particles of posterior probability of existence of a sound source for each direction and time based on the estimated posterior distribution of model parameters.

### TECHNICAL FIELD

The present invention relates to a system and a method for determining positions of sound sources.

### BACKGROUND ART

Determination of positions of sound sources is an essential technology used for separation of complex mixed speeches that uses a microphone array, for provision of sound source direction to an operator of a remote controlled robot, and for detection of sound sources and estimation of the positions of the same by a moving robot.

The method for sound source determination utilizing a microphone array includes a method based on beam forming and a method based on Multiple Signal Classification (MUSIC). The MUSIC method is robust to noise and provides a relatively stable determination of plural sound sources under the conditions that the number of sound sources is less than the number of microphones (for example, refer to Japanese patent No. 4095348).

With a regular MUSIC method, a threshold is set to an evaluation function for incoming sound sources called MUSIC spectrum, and determination is made if a sound source lies in a certain direction. An appropriate determination of the threshold value requires consideration on the number of sound sources and reverberation time in the environment. Accordingly, determination of positions of sound sources where sound environment dynamically changes required manual setting of the threshold values. That is, no systems or methods have so far been developed that provide automatic setting of the threshold values for the MUSIC spectrum under the conditions that sound environment dynamically changes.

### SUMMARY OF INVENTION

### Technical Problem

Accordingly, there is a need for a sound source position determining system and method that are capable of automatically determining one or more thresholds for MUSIC spectrum under the condition that a sound environment dynamically changes.

### Solution to Problems

In accordance with one aspect of the invention, the sound source position determining system comprises a detector for detecting sound data, and a unit for computing MUSIC spectrum for each direction and time. The system includes a model parameter estimating unit that determines a state transition model describing transition of the state according to existence or absence of a sound source in each direction and determines an observation model describing MUSIC spectrum observed in the state where one or more sound sources exist and in the state where no sound sources exist. The model parameter estimating unit estimates posterior distribution of the model parameters of the observation model and the state transition model based on temporal data of the MUSIC spectrum. The system further comprises a unit for determining positions of one or more sound sources by sampling particles of posterior probability of existence of a sound source for each direction and time based on the estimated posterior distribution of the model parameters.

According to this aspect of the invention, the sound source position determining system estimates posterior distribution of model parameters of the observation model and the state transition model and determines the positions of one or more sound sources based on the estimated posterior distribution of the estimated model parameters so that a robust determination of one or more positions of one or more sound sources may be made without needing to manually set one or more thresholds in the conditions where a sound environment dynamically changes.

One embodiment of the first aspect of the invention, the sound source position determining system utilizes Gaussian mixture model as the observation model.

According to this embodiment, analytical computation may be made with the use of Gaussian distribution.

According to a second aspect of the invention, a method for determining one or more positions of one or more sound sources comprises the steps of detecting sound data, and computing MUSIC spectrum for each direction and time based on the detected sound data. The method also includes the steps of determining a state transition model that describes state and transition of the state according to existence or absence of a sound source in each direction, and determining an observation model that describes MUSIC spectrum observed in a state where one or more sound sources exist and in a state where no sound sources exist. The method further includes the steps of estimating posterior distribution of model parameters of the observation model and the state transition model base on temporal data of MUSIC spectrum, and determining positions of one or more sound sources by sampling particles of posterior probability of existence of a sound source for each direction and time based on the estimated posterior distribution of model parameters.

According to this aspect of the invention, the sound source position determining method estimates posterior distribution of model parameters of the observation model and the state transition model and determines the positions of one or more sound sources based on the estimated posterior distribution of the estimated model parameters so that a robust determination of one or more positions of one or more sound sources may be made without needing to manually set a threshold in the conditions where a sound environment dynamically changes.

One embodiment of the second aspect of the invention, the sound source position determining method utilizes Gaussian mixture model as the observation model.

According to this embodiment, analytical computation may be made with the use of Gaussian distribution.

In a second embodiment of the second aspect of the invention, the sound source position determining method includes the steps of sampling P particles, calculating weights for respective particles, normalizing weight of each particle, and re-sampling the particles with the use of the weight of each particle.

According to this embodiment, with sampling of the particles based on distribution of the estimated model parameters, particles of sound source posterior probability for each direction and time may be determined with a simple process.

### BRIEF DESCRIPTION OF THE DRAWINGS

FIG. 1 illustrates a structure of sound source position determining system according to one embodiment of the present invention.

FIG. 2 illustrates a structure of a microphone array comprising M microphones.

FIG. 3 illustrates distribution of MUSIC spectrum in a logarithm scale.

FIG. 4 illustrates a graphical model showing conditional independency among probability variables of VB-HMM.

FIG. 5 is a flow chart of a process for estimating a distribution of model parameters with the model parameter estimating unit.

FIG. 6 is a flow chart of a process performed by the sound source position determining unit for determining P particles representing posterior probability of existence of one or more sound sources in each direction bin.

FIG. 7 illustrates placement of sound sources used in an experiment of an online sound source position determination.

FIG. 8 shows results of online sound source position determination with a conventional system.

FIG. 9 shows results of online sound source position determination with the sound source position determination system according to one embodiment of the invention.

### DESCRIPTION OF EMBODIMENTS

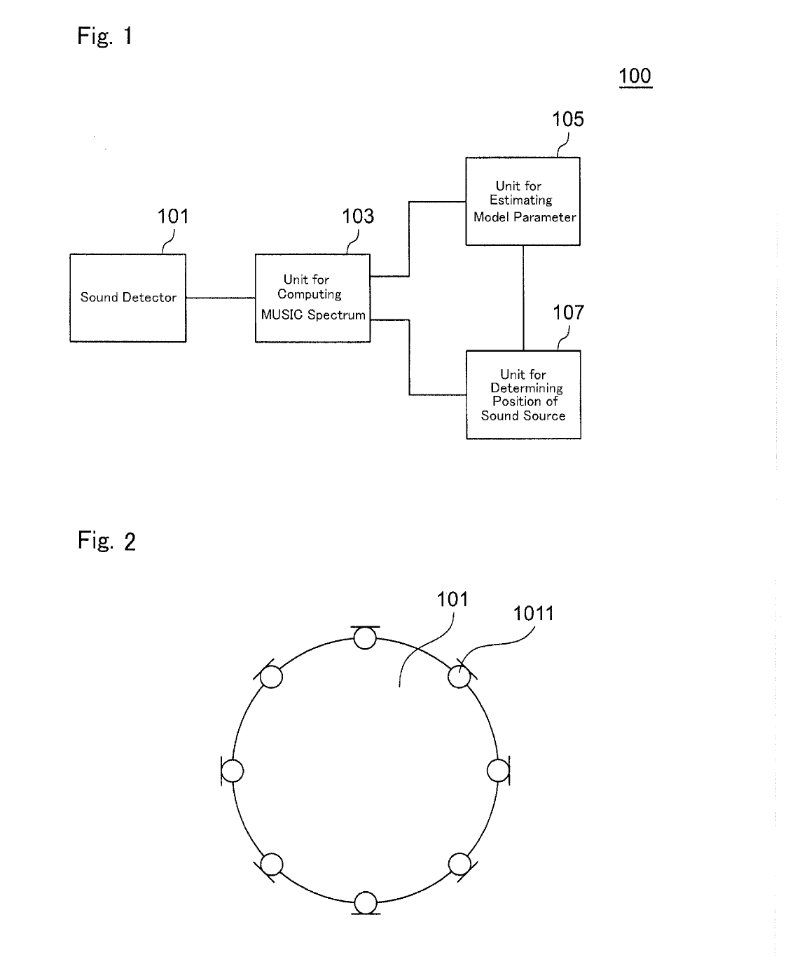

FIG. 1 illustrates a structure of a sound source position determination system 100 in accordance with one embodiment of the invention. The system 100 comprises a sound detector 101, MUSIC spectrum calculating unit 103, a unit 105 for estimating model parameters, and a sound source position determining unit 107.

The sound detector 101 may be a microphone array comprising M microphones.

FIG. 2 illustrates a microphone array 101 comprising M microphones 1011. In FIG. 2, M=8. As an example, the eight microphones are placed on a horizontal plane. The system 100 determines which direction on the horizontal plane one or more sound sources exist. As an example, resolution of direction is 5 degree, enabling determination of which one of 72 directions (360/5=72) a sound source lies.

For example, the microphone array, the sound detector, provides sound signal of M channels. Assume that a transmission function is given for each frequency bin for D directions (D=72) on the horizontal plane. The system 100 determines N sound source directions. The maximum number Nₘₐₓ of the sound sources whose positions may be determined is smaller than the number of microphones.

N≦Nₘₐₓ<M

Now, a scheme of calculating MUSIC (Multiple Signal Classification) spectrum in the MUSIC spectrum calculation unit 103 will be described. The details of this scheme is described in R. O. Schmidt, “Multiple Emitter Location and Signal Parameter Estimation,” IEEE Trans. on Antennas and Propagation, vol. 34, no. 3, pp. 276-280, 1986; P. Danès and J. Bonnal, “Information-Theoretic Detection of Broadband Sources in a Coherent Beamspace MUSIC Scheme,” in Proc. of IROS-2010, 2011, pp. 1976-1981. The MUSIC scheme is applied in a time frequency region. Specifically, at sampling frequency 16000 (Hz), a short period Fourier transformation is performed with window length 12 (pt) and shift width 160 (pt).

x_{τ, ω} ∈ [symbol] ^{M} x_{τ, ω} ∈ C^{M}

This formula represents complex amplitude vector of incoming M channel audio signal at time frame τ, frequency bin ω of M channel audio signal. For each frequency bin ω, time t of ΔT (sec) interval,
(1) self-correlation matrix of input signal calculate

R_{t, ω}
(2) eigenvalue decomposition of R_{t, ω}, and
(3) computation of MUSIC spectrum using eigenvector and transmission function, are performed.

The above items (1) through (3) will be described below.
(1) calculation of self-correlation matrix of input signal

$${R}_{t , ω} = \frac{1}{{τ}^{′} ( t ) - {τ}^{′} ( t - Δ T )} {\sum }_{τ = {τ}^{′} ( t - Δ T )}^{{τ}^{′} ( t )} {x}_{τ , ω} {x}_{τ , ω}^{H} \qquad ( 1 )$$

(·)^{H}

is Hermitian transposition.

\acute{τ}(t)

is a time frame at time t.

M elements of the input vector x_{τ, ω} correspond to respective channels.
(2) Eigenvalue decomposition

R_{τ, ω}

is eigenvalue decomposed as follows.

R_{t, ω}=E_{t, ω}^{H}Q_{t, ω}E_{t, ω} (2)

E_{t, ω}

is eigenvector.

Q_{τ, ω}

is represented by M eigenvectors of

E_{t, ω}=[e_{t, ω}¹ . . . e_{t, ω}^{M}]

and

R_{t, ω}

Q_{t, ω}=diag(q_{t, ω}¹ . . . q_{t, ω}^{M})

Eigenvalue

q_{t, ω}^{m}

is placed in a descending order.

If N sound sources are included in input signal, eigenvalues from

q_{t, ω}¹

to

q_{t, ω}^{N}

have large values corresponding to energy of respective sound sources. In contrast, remaining eigenvalues from

q_{t, ω}^{N+1}

to

q_{t, ω}^{M}

have small values corresponding to observed noise of the microphones. It should be noted that eigenvectors from

e_{t, ω}^{N+1}

to

e_{t, ω}^{M}

that correspond to noise are orthogonal to transmission function vector corresponding to the direction of sound source. [R. O. Schmidt, “Multiple Emitter Location and Signal Parameter Estimation,” IEEE Trans. on Antennas and Propagation, vol. 34, no. 3, pp. 276-280, 1986.]
(3) Calculation of MUSIC spectrum using eigenvectors and transmission function MUSIC spectrum is calculated with the following equation.

$${P}_{t , d , ω} = \frac{‖ {a}_{d , ω}^{H} {a}_{d , ω} ‖}{{\sum }_{m = {N}_{max} + 1}^{M} ‖ {a}_{d , ω}^{H} {e}_{t , ω}^{m} ‖} \qquad ( 3 )$$

a_{d, ω} is M dimensional transmission function vector corresponding to direction d, frequency bin ω. These transmission functions are measured in advance utilizing the microphone array. The maximum number of sound sources that may be observed is Nₘₐₓ. Accordingly, eigenvectors from

e_{t, ω}N^{ₘₐₓ}⁺¹

to

e_{t, ω}^{M}

are orthogonal to the following transmission function a_{d, ω} corresponding to direction d of the sound source. Thus, the denominator of the equation (3) becomes zero in the direction d of the sound source. That is, the MUSIC spectrum P_{t, d, ω} of equation (3) diverges. In reality, however, the MUSIC spectrum is observed as a sharp peak and does not diverge due to the influence of miscellaneous sounds including those reflected at the walls.

Now, MUSIC spectrum for each frequency bin is calculated with the following equation:

P′_{t, d}=Σ_{ω=ω}_{ₘᵢₙ}^{ω}^{ₘₐₓ}\sqrt{q_{t, d}¹}P_{t, d, ω} (4)

Here,

q_{t, d}¹

is eigenvalue in frequency bin ω. In the present embodiment, as voice signal is handled, ωₘᵢₙ and ωₘₐₓ are:

ωₘᵢₙ=500(Hz)

ωₘₐₓ=2800(Hz)

Now, the function of the model parameter estimating unit 105 will be described. The unit 105 utilizes variational Bayesian hidden Markov model (VB-HMM).

D dimensional binary vector is used for state vector. Vector value for each dimension indicates whether or not a sound source lies in that direction.

MUSIC spectrum is assumed to be observation values according to the Gauss distribution, the observation model being Gauss mixture distribution comprising Gauss distributions for a case where at least one sound source lies and for a case where no sound sources lie. Gauss distribution is used because logarithmic MUSIC spectrum with a plurality of frequency bins takes approximately a form of Gauss distribution, and because analytical calculation may readily be made for Gauss distribution.

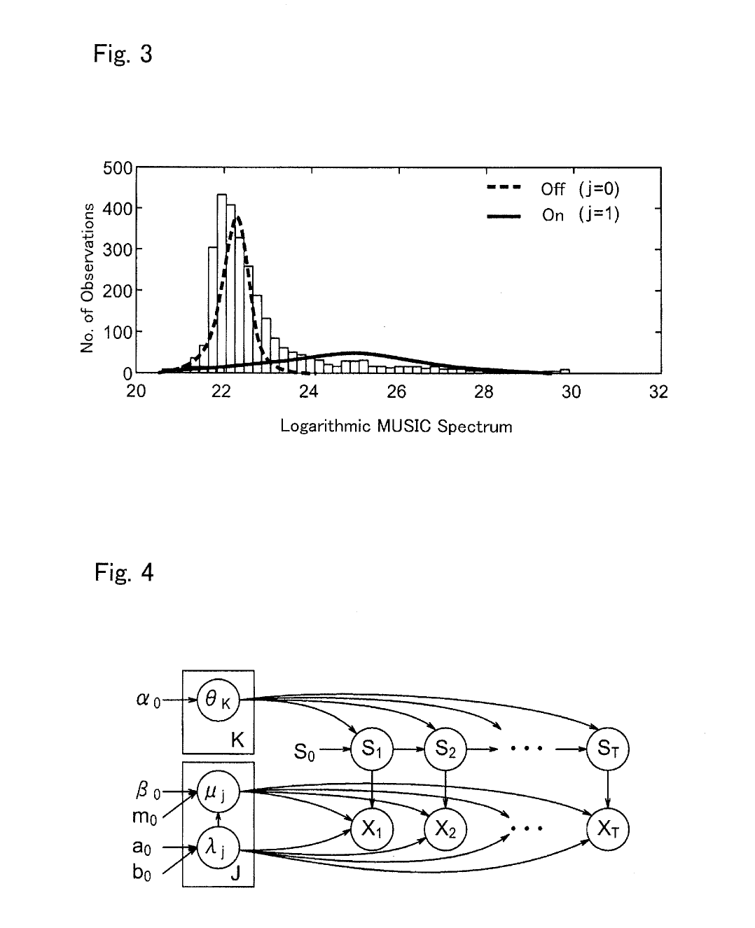

FIG. 3 illustrates a distribution of MUSIC spectrum in a logarithmic scale. The lateral axis represents MUSIC spectrum in the logarithmic scale. The MUSIC spectrum in the logarithmic scale is determined by the following equation:

x_{t, d}=10 log10P′_{t, d} (5)

The vertical axis of FIG. 3 represents the number of observations. The Gauss distribution with no sound sources (off state) is shown with a dotted line, which is formed in a narrow small MUSIC spectrum region. The Gauss distribution with at least one sound source (on state) is shown with a solid line, which covers a wide large region of the MUSIC spectrum.

The observation model used in the model parameter estimation unit 105 may be represented by the following equation:

$$p ( {x}_{t} \vert {s}_{t} , μ , λ ) = {\prod }_{d = 1}^{D} {\prod }_{j = 0}^{1} N ( {x}_{t , d} {\vert {μ}_{j} , {λ}_{j}^{- 1} )}^{{δ}_{j} ( {s}_{t , d} )} \\ {δ}_{y} ( x ) = 1 if x = y , \\ otherwise {δ}_{y} ( x ) = 0 \\ N ( \cdot \vert μ , {λ}^{- 1} ) \qquad ( 6 )$$

represents probability density function of normal distribution with an average μ and accuracy λ. For parameters μ and λ, normal/Gamma distribution is used.

$$p ( μ , λ \vert {β}_{0} , {m}_{0} , {a}_{0} , {b}_{0} ) = {\prod }_{j = 0}^{1} N ( {μ}_{j} \vert {m}_{0} , {( {β}_{0} {λ}_{j} )}^{- 1} ) G ( {λ}_{j} \vert {a}_{0} , {b}_{0} ) \qquad ( 7 )$$

Here, N(•|m, L⁻¹) is a normal distribution of an average m, accuracy L (variance 1/L), and may be represented by the following equation:

$$N ( x \vert m , {L}^{- 1} ) = \sqrt{\frac{L}{2 π}} exp ( - \frac{{L ( x - m )}^{2}}{2} )$$

G(•|a, b) is Gamma distribution of shape a, scale b, and may be represented by the following equation:

$$G ( x \vert a , b ) = \frac{{b}^{a}}{Γ ( a )} {x}^{a - 1} exp ( - bx )$$

β of the normal distribution, a of Gamma distribution represent magnitude of the influence of prior distribution. In this embodiment, rather than prior information, data acquired during learning process are taken into consideration with the initial values set as β₀=1 and β₀=1.

m₀ is an average obtained from prior information for the average parameter μ and is approximately 25 in this embodiment. Or, sampling average of the observation values to be used in VB-HMM may be used.

b₀ is “unevenness” of the accuracy parameter λ provided by the prior information and is set to 500 for experiment. It may be sampling variation of the observed values for use in learning VB-HMM.

FIG. 4 illustrates a graphical model of conditional independency among probability variables of VB-HMM. In the VB-HMM, parameter θₖ of state transition probability, and parameters μ, λ of observation probability are not numerical values but are probability variables, which differs from a regular HMM. The model parameter estimating unit 105 learns probability distribution of these parameters.

The state transition model used in the unit 105 is:

s_{t, d}=0 if there in no sound sources in the previous state, and

s_{t, 1d}=1 if there is a sound source.

Thus, transitions in the next state such as appearance of a sound source, continuation of the sound source, and extinction of the sound source are considered. In the present embodiment, moving sound sources are also taken into consideration. As shown in Table 1 below, there are four cases in the combination of the prior state. Classification is made based on whether a sound source lies in the same direction bin s_{t-1, d} and whether a sound source lies in the adjacent direction bin s_{t-1, d±1}. For example, θ¹ is a probability that a sound source appears from the state that there are no sound sources in the direction d and adjacent bin d±1 in the previous time, and θ2 is a probability that a sound source that did not exist in the direction d but existed in the adjacent bin d±1 in the previous time moves to the direction d to make s_{t, d}=1.

TABLE 1

| Previous State | Previous Adjacent State | Probability of Sound Source |
|---|---|---|
| S_{t-1,d} | 1 − s_{t-1,d-1}S_{t-1,d+1} | p(s_{t,d} = 1\|s_{t-1,d-1:d+1}) |
| 0 (off) | 0 | θ ₁ |
| 0 (off) | 1 | θ ₂ |
| 1 (on) | 0 | θ ₃ |
| 1 (on) | 1 | θ ₄ |

The state transition probability may be represented by the following equation:

$$p ( {s}_{t} \vert {s}_{t - 1} , θ ) = {\prod }_{d = 1}^{D} {\prod }_{k = 1}^{4} {\prod }_{{S}_{t , d} = 0}^{1} {( {{θ}_{k}^{{s}_{t , d}} ( 1 - {θ}_{k} )}^{1 - {s}_{t , d}} )}^{{f}_{k} ( {s}_{t - 1 , d} )} \qquad ( 8 )$$

Here, in accordance with Table 1, when fₖ(sₜ₋₁, d) meets condition k according to the value s_{t-1, d-1}, s_{t-1, d}, and d_{t-1, d+1} of the previous state around the direction bin d, the following equation establishes:

fₖ(t, d)=1

In the other cases, condition identifying function that returns 0 is established. For the initial state, sound sources do not exist. Thus, for all d, the following equation establishes:

s_{0, d}=0

For the following state transition parameter:

θ=[θ₁, . . . , θ₄]

a beta distribution is used for the conjugate prior distribution of the formula (8).

$$p ( θ \vert {α}_{0} ) = {\prod }_{k = 1}^{4} B ( {θ}_{k} \vert {α}_{0 , 0} , {α}_{0 , 1} )$$

B(−|c, d) is a probability density function of a β distribution having parameters c and d.

Learning of VB-HMM at the model parameter estimating unit 105 is performed by approximating posterior distribution p(s_{1:T}, θ, μ, λ|x_{1:T}) into a distribution that may be factorized as follows:

$$p ( {s}_{1 : T} , θ , μ , λ \vert {x}_{1 : T} ) \approx q ( {s}_{1 : T} , θ , μ , λ ) , = q ( {s}_{1 : T} ) q ( θ ) q ( μ , λ ) , \qquad ( 10 )$$

(•)_{1:T} is a set of probability variables from time 1 to T. Inference of VB-HMM is described in M. J. Beal, “Variational Algorithms for Approximate Bayesian Inference,” Ph.D. dissertation, Gatsby Computational Neuroscience Unit, University Colledge London, 2003.

q(θ)=Πₖ q(θₖ)

is a beta distribution having parameters \hat{α}_{k, 0}, \hat{α}_{k, 1} shown in equation (11).

q(μ, λ)=┌ⱼ q(ρⱼ, λⱼ)

is a normal Gauss distribution having parameters shown in equation (12) and (13).

$$\begin{matrix}{\hat{α}}_{k , j} = {α}_{0 , j} + {\sum }_{t , d} ( {s}_{t , d , j} {f}_{k} ( {s}_{t - 1} , d ) ) , & ( 11 ) \\ {\hat{β}}_{j} = {β}_{0} + {w}_{j} , {\hat{m}}_{j} = ( {β}_{0} {m}_{0} + {w}_{j} {\overline{x}}_{j} ) / ( {β}_{0} + {w}_{j} ) , & ( 12 ) \\ {\hat{a}}_{j} = {a}_{0} + \frac{{w}_{j}}{2} , {\hat{b}}_{j} = {b}_{0} + \frac{{w}_{j} {S}_{j}^{2}}{2} + \frac{{β}_{0} {{w}_{j} ( {\overline{x}}_{j} - {m}_{0} )}^{2}}{2 ( {β}_{0} + {w}_{j} )} , & ( 13 )\end{matrix}$$

Here, variable s_{t, d} is a variable that assumes:

s_{t, d, 0}=1 if s_{t, d}=0, and

s_{t, d, 1}=1 if s_{t, d}=1

Sufficient statistical amount of the normal distribution used in equations (12) and (13) is defined as:

$${w}_{j} = {\sum }_{t , d} 〈 {s}_{t , d , j} 〉 , {\overline{x}}_{j} = \frac{{\sum }_{t , d} ( {s}_{t , d , j} ) {x}_{t , d}}{{w}_{j}} , {S}_{j}^{2} = \frac{{\sum }_{t , d} ( {s}_{t , d , j} ) {( {x}_{t , d} - {\overline{x}}_{j} )}^{2}}{{w}_{j}} .$$

Here, [symbol] - [symbol] is an expected value according to the distribution. State variable and expected values of the state transition at each time are expressed by:

[symbol]

s_{t, d, j} [symbol] , [symbol] s_{t, d, j}fₖ(sₜ₋₁, d)

[symbol]

and is calculated as follows:

[symbol]

s_{t, d, j} [symbol] ∝α(s_{t, d, j})β(s_{t, d, j}), (14)

[symbol]

(s_{t, d, j}fₖ(sₜ₋₁, d) [symbol] ∝\tilde{α}(s_{t-1, d, k})\tilde{p}(s_{t, d}|sₜ₋₁)\tilde{p}(x_{t, d}|s_{t, d})β(s_{t, d, j}), (15)

Here, α(s_{t, d, j}) and β(s_{t, d, j}) are respectively calculated by forward and backward recursive formulas:

$$\begin{matrix}α ( {s}_{t , d , j} ) ∝ {\sum }_{k = 1}^{4} \tilde{α} ( {s}_{t - 1 , d , k} ) \tilde{p} ( {s}_{t , d} \vert {s}_{t - 1} ) \tilde{p} ( {x}_{t , d} \vert {s}_{t , d} ) , & ( 16 ) \\ β ( {s}_{t , d , j} ) ∝ {\sum }_{{j}^{′} = 0}^{1} β ( {s}_{t + 1 , d , {j}^{′}} ) \tilde{p} ( {s}_{t + 1 , d , {j}^{′}} \vert {s}_{t , d , j} ) \tilde{p} ( {x}_{t , d} \vert {s}_{t , d} ) , & ( 17 )\end{matrix}$$

### Here,

$$\begin{matrix}\tilde{p} ( {s}_{t , d} \vert {s}_{t - 1} ) = C exp ( {E}_{q ( 0 )} [ log p ( {s}_{t , d} \vert {s}_{t - 1} , θ ) ] ) \\ = C exp ( \int log p ( {s}_{t , d} \vert {s}_{t - 1} , θ ) q ( θ ) d θ )\end{matrix}$$

$$\begin{matrix}\tilde{p} ( {x}_{t , d} \vert {s}_{t , d} ) = C exp ( {E}_{q ( μ , λ )} [ log p ( {x}_{t , d} \vert {s}_{t , d} , μ , λ ) ] ) \\ = C exp ( \int \int log p ( {x}_{t , d} \vert {s}_{t , d} , μ , λ ) q ( μ , λ ) d μ d λ )\end{matrix}$$

A geometric average of transition and observation probability can be expressed as follows:

$$\begin{matrix} \tilde{p} ( {s}_{t , d} = j \vert {s}_{t - 1} ) ∝ exp \{ ψ ( {\tilde{α}}_{k , j} ) - ψ ( {\hat{α}}_{k , 0} + {\tilde{α}}_{k , 1} ) \} & ( 18 ) \\ \tilde{p} ( {x}_{t , d} \vert {s}_{t , d} ) ∝ {\prod }_{j} exp {\{ \frac{ψ ( {\hat{α}}_{j} ) - log {\tilde{b}}_{j} - 1 / {\hat{β}}_{j}}{2} - \frac{{{a}_{j} ( {x}_{t , d} - {\hat{m}}_{j} )}^{2}}{2 {b}_{j}} \}}^{s , d , j} & ( 19 )\end{matrix}$$

Here, Ψ( ) is a de-gamma function defined as follows:

$$Ψ ( x ) ≡ \frac{d}{d x} log Γ ( x )$$

Formulas (14) and (15) are respectively normalized such that the sum becomes 1 when j and k are varied.

\tilde{α}(s_{t-1, d, k}) is a forward probability for condition k of the state transition.

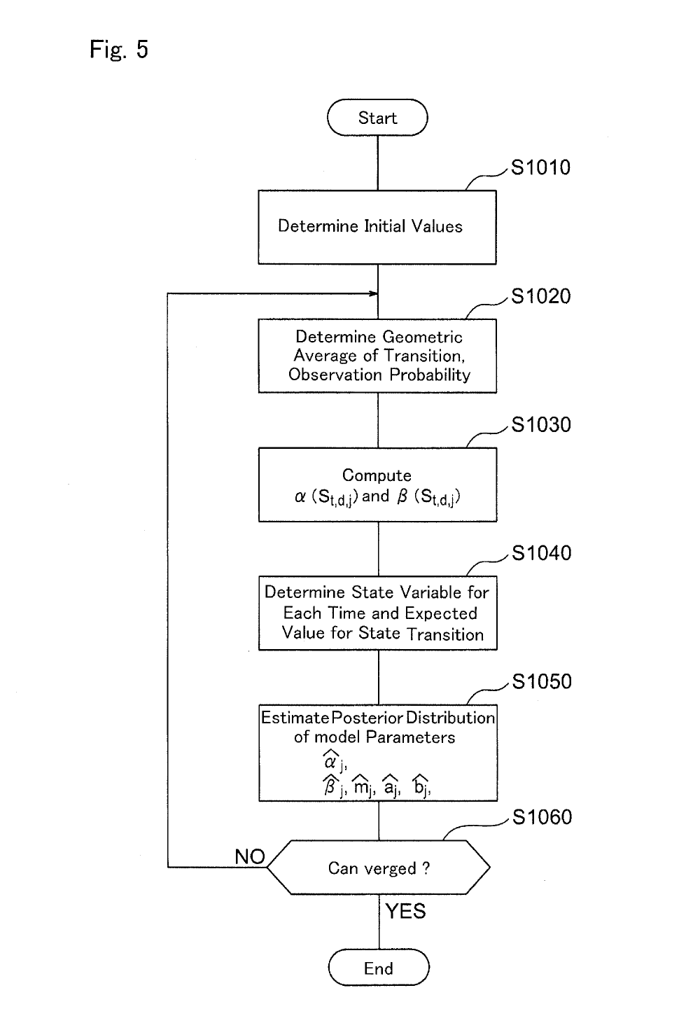

FIG. 5 is a flow chart showing the process of estimating the distribution of model parameters by the model parameter estimating unit 105.

At step S1010 in FIG. 5, the model parameter estimating unit 105 sets an initial value. The initial value may be set for the values of formulas (14) and (15) with the following steps.

The left side of formula (14), <s_{t, d, j}> is an expected value of a binary variable, which assumes at time t, direction bin d:

s_{t, d, 0}=1 and s_{t, d, 1}=0 if there are no sound sources, and

s_{t, d, 0}=0 and s_{t, d, 1}=1 if there is at least one sound source

When observation value x_{t, d} exceeds a predetermined threshold value (such as the value of m₀), it is, for example, set as follows:

<s_{t, d, 1}>=0.8,

<s_{t, d, 0}>=1−0.8=0.2

In lieu of 0.8, 1 may be used, which results in a substantially similar operation.

The left side of the formula (15), <s_{t, d, j}fₖ(sₜ, d)> is also calculated according to whether or not x_{t, d} exceeds a threshold value. The value includes a combination of two of s_{t, d}=0, 1 and four of fₖ(sₜ, d)=1 at one of k=1˜4, resulting in eight combinations. The value of k is determined with reference to the table 1 based on the results of threshold handling for x_{t, d}, threshold handling for x_{t-1, d} at preceding time, and threshold handling for x_{t-1±1}. For example, if x_{t-1, d} at preceding time is below the threshold value and if the threshold value is exceeded at an adjacent bin x_{t-1, d+1}, k assumes k=2. If x_{t, d} exceeds the threshold value, <s_{t, d, 1}f₂(sₜ, d)>=0.8, and in the other seven combinations, setting is made like <s_{t, d, j}fₖ(sₜ, d)>=(1−0.8)/7.

At step S1020, the model parameter estimating unit 105 determines geographic average of the transitions and observation probability utilizing the formulas (18) and (19).

At step S1030 in FIG. 5, the model parameter estimating unit 105 calculates α(s_{t, d, j}) and β(s_{t, d, j}) utilizing the geographic average of the transition and the observation probability determined in step S1020 and utilizing formulas (16) and (17).

At step S1040, the model parameter estimating unit 105 determines the expected values for the state variable and the state transition at each time utilizing α(s_{t, d, j}) and β(s_{t, d, j}) determined in step S1030 and the formulas (14) and (15).

At step S1050, the model parameter estimating unit 105 calculates posterior distribution of the model parameters utilizing the expected values for the state variable and the state transition as determined in step S1040 and utilizing formulas (11) through (13).

At step S1060, the unit 105 determines on convergence. Specifically, the unit 105 determines convergence by finding that the values of parameters β, m, a, and b calculated by the formulas (12) and (13) do not vary. If convergence is not found, the process returns to step S1020. If convergence is found, the process terminates.

Now, the function of the sound source position determining unit 107 will be described. The unit 107, based on the posterior distribution of the model parameters estimated by the model parameter estimating unit 105, calculates posterior probability of existence of a plurality of sound sources. The particle filter infers posterior probability of existence of a sound source in each direction bin when temporal data of MUSIC spectrum is given. This distribution is approximated as follows utilizing p particles:

p(sₜ|x_{1:t})≈wₚsₜ^{p}, (20)

Here, wₚ is a weight of particle p, sₜ^{p} is a value of the state vector.

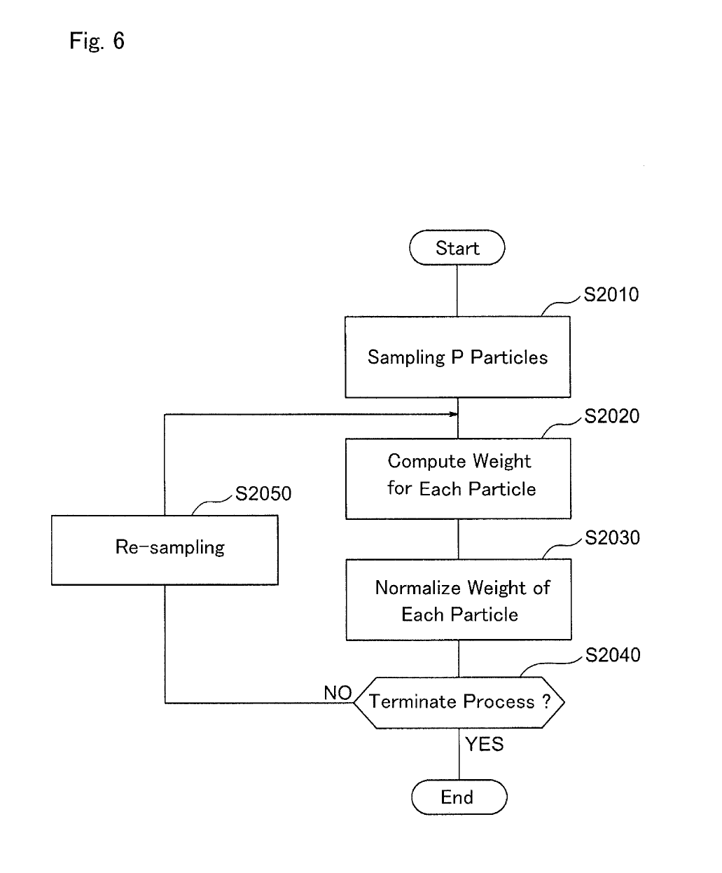

FIG. 6 is a flow chart showing the steps performed by the unit 107 for determining P particles which represents posterior probability of existence of a sound source in each direction bin.

At step S2010, the unit 107 acquires P particles by sampling.

P is determined as follows. The larger P is, the better is the proximity by the formula (2), but it will require computation time proportional to the magnitude of P. Thus, as a general procedure, P is made large enough to achieve practical proximity, and if the time for processing P is too large, the magnitude of P is decreased. In this embodiment, P is set as P=500 with an expectation that proximity results will converge and the process will be fast enough.

Sampling of P particles is done using the distribution expressed by the following formulas:

$$\begin{matrix}{s}_{t}^{p} ∼ q ( {s}_{t} \vert {x}_{t} , m , a , b ) , & ( 21 ) \\ q ( {s}_{t}^{P} \vert {x}_{t} , \hat{m} , \hat{a} , \hat{b} ) ∝ {\prod }_{d = 1}^{D} {\prod }_{j = 0}^{1} {C ( {x}_{t , d} )}^{{s}_{t , d , 1}^{p}} {exp ( - {Δ}_{d , j}^{2} / 2 )}^{{s}_{t , d , j}^{P}} & ( 22 )\end{matrix}$$

Here,

C(x_{t, d})=1 when x_{t, d} is d, a peak value,

Otherwise,

C(x_{t, d})=0

Maharanobis's distance expressed by the following equation is used for the weights for the above distribution.

Δ_{d, j}²=(x_{t, d}−\hat{m}ⱼ)²aⱼ/\hat{b}ⱼ

At time t, the distribution q computed by the equation (22) for the total D bins provides probability of:

ON(s_{t, d, 1}^{p}=1), or

OFF(s_{t, d, o}^{p}=1).

For sampling, fore each d,

a) when C(x_{t, d})=0, j=0 that is s_{t, d, 0}^{P}=1

b) when C(x_{t, d})=1, probability of distribution q is referred to for each of j=0,

1. For example, when

exp(−Δ_{d, 0}²): exp(−Δ_{d, 1}²)=8:2,

uniform random numbers are produced from the section of 0˜1, and

if the number is not larger than 0.8, s_{t, d, 0}^{P}=1, and

if the number exceeds 0.8, s_{t, d, 1}^{P}=1

At step S2020 in FIG. 6, the sound source position determining unit 107 calculates weights wₚ for each particle in accordance with the following formula:

$$\begin{matrix}{w}_{p} ∝ \frac{\tilde{p} ( {x}_{t} \vert {s}_{t}^{p} ) \tilde{p} ( {s}_{t}^{p} \vert {s}_{t - 1}^{p} )}{q ( {s}_{t}^{p} \vert {x}_{t} , \hat{m} , \hat{a} , \hat{b} )} , & ( 23 ) \\ \tilde{p} ( {x}_{t} \vert {s}_{t}^{p} ) = \int p ( {x}_{t} \vert {s}_{t}^{p} , μ , λ ) q ( μ , λ ) d μ d λ , & ( 24 ) \\ \tilde{p} ( {s}_{t}^{p} \vert {s}_{t - 1}^{p} ) = \int p ( {s}_{t}^{p} \vert {s}_{t - 1}^{p} , θ ) q ( θ ) . & ( 25 )\end{matrix}$$

The state transition and observation probability of the equations (24) and (25) may be computed by integration deletion by posterior distribution of formulas (6) and (8) that are used by the model parameter estimating unit 105. This integral computation may analytically be determined as follows with the use of conjugation of the distribution:

$$\begin{matrix}\tilde{p} ( {x}_{t} \vert {s}_{t}^{p} ) = {\prod }_{d} {st ( {x}_{t , d} \vert {\hat{m}}_{j} , \frac{{\hat{β}}_{j} {\hat{a}}_{j}}{( 1 + {\hat{β}}_{j} ) {\hat{b}}_{j}} , 2 {\hat{a}}_{j} )}^{{s}_{t , d , j}^{p}} & ( 26 ) \\ \tilde{p} ( {s}_{t}^{p} \vert {s}_{t - 1}^{p} ) = {\prod }_{d} {\prod }_{k} {( {\hat{α}}_{k , {s}_{t , d}} / ( {\hat{α}}_{k , 0} + {\hat{α}}_{k , 1} ) )}^{{f}_{k} ( {s}_{t - 1}^{p} , d )} & ( 27 )\end{matrix}$$

Here, St(·(m, λ, v) is Student t-distribution of an average m, accuracy 1 and freedom n. In order to limit the largest number of sound sources to Nₘₐₓ, if the number of sound sources lying in the state vector sₜ^{p} exceeds Nₘₐₓ, the observation probability shall be:

\tilde{p}(sₜ|sₜ^{p})=0

In step S2030 of FIG. 6, the sound source position determining unit 107 normalizes weight wₚ of each particle to be:

Σₚ₌₁^{P} wₚ=1

In step S2040 of FIG. 6, determination made whether the process may be terminated. For example, termination of the process may be determined according to the state of switches. If termination is not determined, the process moves to step S2050. Otherwise, the process terminates.

In step 2050 of FIG. 6, the sound source position determining unit 107 performs re-sampling. Re-sampling is performed by duplicating the value of particle p, sₜ^{p} with a probability proportional to the weight of the particle, wₚ. As an example, the following process is performed for p′=1˜P:

a) uniform random numbers r_{p′} are produced form the section of 0˜1.

b) p=1˜P
i. r_{p′}←r_{p′}·wₚ
ii. if r_{p′}<0,

Sₜ^{p′}←Sₜ^{p}
and exit the loop of p.
iii. w_{p′}←1/P (the weights after re-sampling are the same for all particles.)

c) return to a9).

Now, evaluation experiment will be described. The sound source position determining system of the present embodiment is compared with a conventional sound source position determining system that utilized fixed threshold values. Off-line learning of VB-HMM by the model parameter estimating unit 105 is performed with audio signal produced by a person speaking while he or she moves around the microphones.

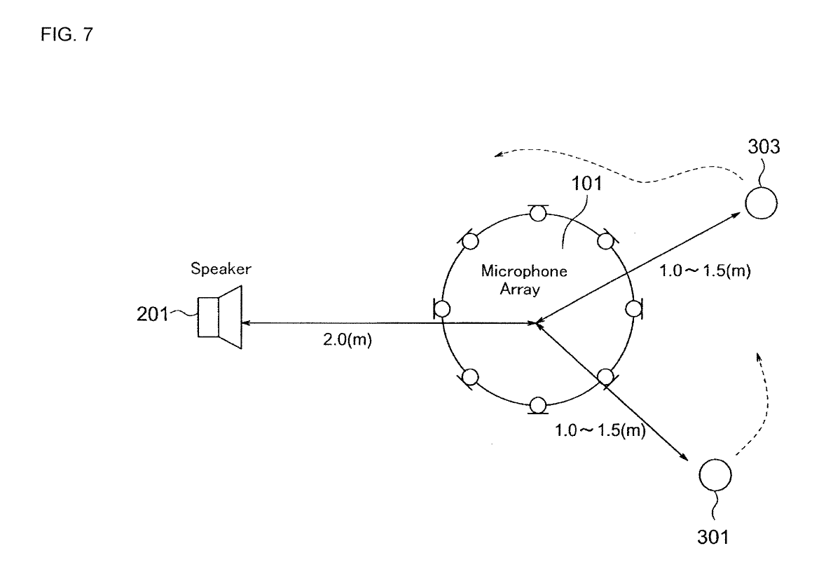

FIG. 7 illustrates placement of the sound sources that were used for on-line sound source position determination experiment. Two persons 301 and 302 speak while moving around an array of microphones 101. A speaker 201 is placed still and produces musical sound. The length of signal used for off-line and on-line test is uniform and is 20 (sec).

The parameters are set as follows:

Nmax=3, α₀=[1, 1], β₀=1, a₀=1, b₀=500

The number of particles was P=500. The reverberation time of the room used for the test was RT₂₀0 =840 (msec).

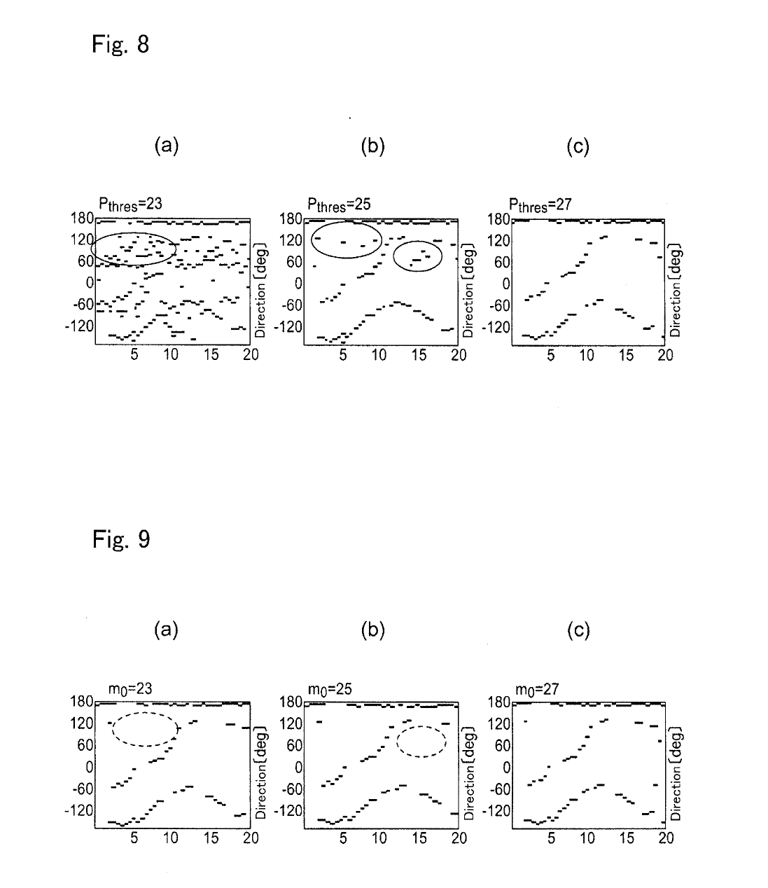

FIG. 8 shows test results of the conventional system. The horizontal axis indicates time in seconds and the vertical axis indicates direction in angle (degree). The threshold values of the conventional system are set to Pthres=23, 25, 27. (a), (b) and (c) in FIG. 8 respectively show the results for the threshold values 23, 25, and 27. In (a), (b) and (c) of FIG. 8, bins exceeding the threshold are shown in black to indicate existence of a sound source. In (a), (b) and (c) of FIG. 8, a fixed speaker and moving and speaking persons are shown in black. When the threshold is set low, detection errors take place often as shown in solid line sieges in FIGS. 8(a) and (b).

FIG. 9 shows the results of sound source position determination with the system according to one embodiment of the present invention. The horizontal axis indicates time in seconds and the vertical axis indicates direction in angles (degrees). The initial values for this embodiment are set to m₀=23, 25, 27. In FIG. 9, (a), (b) and (c) respectively shows the cases sound source position determination for the initial values 23, 25, and 27. In FIG. 9, (a), (b) and (c), the bins with the probability of posterior distribution for existence of a sound source larger than 0.95 are shown in black. In FIG. 9, (a), (b) and (c), the fixed speaker and moving speaking persons are shown in black. The dotted line sieges in FIG. 9, (a), (b) and (c) correspond to the solid line sieges in FIGS. 8(a), (b) and (c) and do not include detection errors for the sound sources. Thus, the system according to one embodiment of the present invention does not cause detection errors for the sound source irrespective of the initial values for learning. Also, the threshold for the probability of existence of a sound source in the system of the embodiment was changed from 0.95 to 1.00 and it was observed that the system is robust and produces similar results for the various threshold values. Thus, the framework of the online learning with the model parameter estimating unit 105 according to the embodiment of the present invention online position determination with the sound source position determining unit 107 produces conversion to the parameters that are suitable for sound source position determination. Further, the sound source position determination method according to the embodiment produces a stable results of sound source position determination for a plurality of sound sources, even if the learning is performed for a single sound source.

1. A sound source position determining system, comprising:
a detector for detecting sound data;
a computing unit for computing MUSIC spectrum for respective directions and times based on the detected sound data;
an estimating unit that determines a state transition model describing the state and transition of the state according to existence or absence of a sound source in each direction, and an observation model describing MUSIC spectrum observed in the state of existence of the sound source and in the state of absence of the sound source, the estimating unit, based on temporal data of the MUSIC spectrum, computing estimated posterior distribution of model parameters for the observation model and the state transition model; and
a sound source position determining unit, based on the posterior distribution of the estimated model parameters, determining the position of the sound source by sampling particles of the posterior

2. The system of claim 1 wherein Gaussian mixture model is used for the observation model.

3. A method for determining a position of a sound source, comprising:
detecting sound data;
computing MUSIC spectrum for respective directions and times based on the detected sound data;
determining a state transition model describing the state and transition of the state according to existence or absence of a sound source in each direction, and an observation model describing MUSIC spectrum observed in the state of existence of the sound source and in the state of absence of the sound source, and based on temporal data of the MUSIC spectrum, computing estimated posterior distribution of model parameters for the observation model and the state transition model; and
based on the posterior distribution of the estimated model parameters, determining the position of the sound source by sampling particles of the posterior

4. The method of claim 3 wherein Gaussian mixture model is used for the observation model.

5. The method of claim 3 wherein determining the position of the sound source comprises:
sampling P particles;
computing weight for each particle;
normalizing the weight for each particle; and
re-sampling the particles using the weight for each particle;
